(19) United States
(12) Patent Application Publication
(10) Pub. No.: US 2024/0392763 A1
(43) Pub. Date: Nov. 28, 2024

(54) COMPLIANT CLOSED CELL UNIVERSAL JOINT

(71) Applicant: TECHNISCHE UNIVERSITEIT DELFT, Delft (NL)

(72) Inventors: Joep Peter Abram NIJSSEN, Delft (NL); Ronald Adrianus Johannes VAN OSTAYEN, Delft (NL); Dave Dominic SONNEVELD, Delft (NL)

(73) Assignee: TECHNISCHE UNIVERSITEIT DELFT, Delft (NL)

(21) Appl. No.: 18/691,682

(22) PCT Filed: Sep. 13, 2022
(86) PCT No.: PCT/NL2022/050517

§ 371 Date: Mar. 13, 2024

(30) Foreign Application Priority Data
Sep. 15, 2021 (NL) 2029186

(51) Int. Cl. F04B 1/146; F16C 11/08

(52) U.S. Cl. CPC F04B 1/146; F16C 11/08

(57) ABSTRACT

The present invention is in the field of mechanical engineering, and in particular of an engineering element for maintaining effective functioning of a machine or installation, such as for a piston pump. The present invention relates to a universal joint, such as for said piston pump, a use of said universal joint, and a product comprising said universal joint.

### RELATED APPLICATIONS

This application is a national entry of PCT International Patent Application No. PCT/NL2022/050517, filed Sep. 13, 2022, in the name of “TECHNISCHE UNIVERSITEIT DELFT” [NL], which PCT application claims the benefit of priority of Netherlands Patent Application Serial No. 2029186, filed Sep. 15, 2021, in the name of “TECHNISCHE UNIVERSITEIT DELFT” [NL]. The entire contents of the above-referenced applications and of all priority documents referenced in the Application Data Sheet filed herewith are hereby incorporated by reference for all purposes.

### FIELD OF THE INVENTION

The present invention is in the field of mechanical engineering, and in particular of an engineering element for maintaining effective functioning of a machine or installation, such as for a piston pump. The present invention relates to a universal joint, such as for said piston pump, a use of said universal joint, and a product comprising said universal joint.

### BACKGROUND OF THE INVENTION

In engineering two or more solid elements of a machine or the like may be connected together, and still allowing relative movement. For instance, a hinge is a mechanical bearing for connecting of such elements, rotation between them over a limited angle. A hinge has one degree of freedom. Another example is a joint, which may be considered as a kinematic pair. The joint imposes constraints on the relative movement of the two or more solid elements being connected by the joint. A special type of joints are compliant joints. A compliant joint gains at least some of its mobility from the deflection of flexible members rather than from movable joints only. A compliant joint uses elastic deformation of flexible elements to generate motion. It is designed to prevent effects like wear, backlash, stick-slip behavior and the need for lubrication. Significant disadvantages are a limited support stiffness and risk of buckling when the joint is loaded in compression. Although solutions have been presented in literature, a decreasing performance during rotation and a trade-off between a high axial and low rotation stiffness seems inevitable by using solid leaf flexures. In an alternative so-called closed form pressure balancing may be used. However, little is known on the theory of this design principle so far.

Some documents recite universal joints or the like. WO2004/113724 A1 discloses a universal joint for a wobble piston pump. US2002046645 also recites a universal joint for a wobble piston pump. US2004/232624 A1 recites a flange coupling wherein between the flanges a closed annular sealing material is arranged for providing a flexible joint. These universal joints/coupling do not comprise a fluid. GB1226690 recites an annular space pressurized and filed with a sealing fluid. CA2991611 recites a rod assembly providing a degree of rotational freedom while limiting the longitudinal freedom.

Further, reference can be made to EP 0 687 823 B1 recites a ball-and-socket joint including a journal having a ball on one end. A plastic housing has a socket and an opening through which the ball is inserted into the socket. The socket is defined by a plurality of circumferentially spaced segmented bearing surfaces having a partially spherical shape and being formed by a plurality of circumferentially spaced radially extending slits. The plurality of slits extend axially from the opening to at least an equator of said socket. The housing includes a ring groove extending axially from the opening to at least the equator. The ring groove encircles the plurality of segmented bearing surfaces. A locking ring is in the ring groove in the housing. The locking ring elastically deforms the plurality of segmented bearing surfaces to position the ball in a first position in the socket against the plurality of segmented bearing surfaces. US 2020/088231 A1 recites sealing bellows made of an elastomeric material includes: a first end face; a second end face; and a casing having a central axis, the casing being arranged in an axial direction between the first and second end faces, the casing including at least one torsion-compensating element for absorbing torsional movements introduced into the sealing bellows substantially without torsional stress. The first end face includes a first static seal and the second end face includes a second static seal. The sealing bellows is made of a TPE material.

It is therefore considered difficult to design a compliant joint that prevent movement in selected directions, and at the same time to deal with compressive forces on the joint

The present invention relates in particular to an improved universal joint and various aspects thereof which overcomes one or more of the above disadvantages, without jeopardizing functionality and advantages.

### SUMMARY OF THE INVENTION

The present invention relates in a first aspect to a compliant closed cell universal joint, wherein the compressive force on the joint is transformed through compression and deformation of the media inside the closed cell to a tensile stress in the elastic enclosure, and the tensile elements inside the void, or outside the void, or in the wall of the enclosure, prevent movement of the joint in selected directions. The present compliant closed cell universal joint 1 comprises a hollow elastic body 10 having a wall 11, the wall being part of the elastic body and hence being elastic, the elastic body adapted to comprise an elastic material inside said body, the elastic body typically having a disk-like shape, such as a circular, ellipsoidal, multigonal, or spherical shape, typically with rounded corners or a rounded wall part connecting a first and second side 10a,b, having an outer diameter O_{d}, the elastic body having a height H, the elastic body having a volume V, a first side 10a, a second side 10b opposite of the first side, at least one central axis, which may be considered as a symmetry axis, and a body deformation restriction member 12, which may be regarded as a unit of the present compliant closed cell, or a mechanism thereof, the body deformation restriction member attached to the wall and/or incorporated into the wall, such as attached to an inner side of the wall, for providing shear stiffness in a plane perpendicular to the at least one central axis, and an elastic material with a substantially constant density p inside the hollow elastic body, or a mixture of such materials, preferably an elastic material with a bulk modulus of 0.5-10 GPa, such as 1-5 GPa (ISO 9110-1:1990 EN), and/or preferably a density ρ of 0.8-3 kg/dm³ in particular according to ISO 12154:2014(en), preferably a material with a Poisson's ratio of 0.48-0.50 in particular according to ASTM D638, ISO 527, in particular about or exactly 0.50, such as an elastic solid material, a liquid, or a high density gas. In the present compliant closed cell universal joint a so-called center of rotation may be present (see e.g. FIG. 1B, schematically represented by the circle therein). The center of rotation is typically located on the central axis, within the body restriction member 12, such that in use said center of rotation remains on the same spatial location. Said body deformation restriction member may be partitioned into sub-parts, in particular, if present, an eccentric member 14 thereof. The body deformation restriction member may have a central symmetry axis. When using e.g. cables the center of rotation is in the location where the cables join or come together. Such cables may have a cable stiffness (tear strength) 10⁴-10⁶ N/m [e.g. using ISO 17893:2004/DIN ISO 34-1Bb], and a typical cable diameter of 0.01-5 mm, such as 0.1-1 mm. The first side 10a and second side 10 b typically are substantially flat, such as to attach the present universal joint to an external parts, such as the piston of a piston pump. The flat side may have a diameter L₀. L₀ is preferably larger than two times the height H. Likewise the thickness of the wall t₀ is preferably smaller than 0.1 times the height H, such as 0.01-0.05 times the height.

In a second aspect the present invention relates to a method relates to a method of producing the present compliant closed cell universal joint, comprising providing a hollow elastic body (10) having a wall (11), the elastic body having an outer diameter O_{d}, the elastic body having a height H, the elastic body having a volume V, a first side (10a), a second side (10b) opposite of the first side, at least one central axis, providing a body deformation restriction member (12) inside the hollow elastic body, the body deformation restriction member attached to the wall and/or incorporated into the wall, for providing shear stiffness in a plane perpendicular to the at least one central axis, and providing an elastic material with a constant density ρ inside the hollow elastic body, preferably an elastic material with a bulk modulus of 0.5-10 GPa, such as 1-5 GPa (ISO 9110-1:1990 EN), and/or preferably a density ρ of 0.8-3 kg/dm³, preferably a material with a Poisson's ratio of 0.48-0.50, such as an elastic solid material, a liquid, or a high density gas, and providing at least one attachment member (40), the attachment member being connected to a first or second side (10a,b) of the hollow elastic body (10).

In a third aspect the present invention relates to a use of the present compliant closed cell universal joint for pressure balancing, in particular for a piston, a piston pump, such as a wobble plate piston pump, a swashplate piston pump, a bearing element, a wind turbine, an axial piston pump, for providing high liquid pressure, an industrial robot with limited axial freedom, and a hinge.

In a fourth aspect the present invention relates to a product comprising the present compliant closed cell universal joint, such as a piston, a piston pump, such as a wobble plate piston pump, a swashplate piston pump, a bearing element, a wind turbine, an axial piston pump, an industrial robot with limited axial freedom, and a hinge.

The present compliant closed cell universal joint and aspects thereof provide significant advantages over the prior art. By using an incompressible fluid no decreasing support stiffness during rotation is obtained and risk of buckling no longer is a limitation. It is found that analytical models can be used to determine e.g. axial stiffness, in comparison to an inflated cylinder, and rotational & shear stiffness. The characteristic behavior of the present joint typically is found to have a center of rotation in a middle of joint; optimal stiffness performance may be obtained by increasing a length L0 of the present joint, and reducing thickness of the wall.

The present invention is also subject of a thesis by D. D. Sonneveld, “Development of compliant joints using closed form pressure balancing”, which thesis and its contents are incorporated by reference.

Thereby the present invention provides a solution to one or more of the above-mentioned problems.

Advantages of the present description are detailed throughout the description. References to the figures are not limiting, and are only intended to guide the person skilled in the art through details of the present invention.

### DETAILED DESCRIPTION OF THE INVENTION

In an exemplary embodiment of the present compliant closed cell universal joint the body deformation restriction member 12 is symmetrical with respect to the central axis, such as with an n-fold axis, wherein n≥6, in particular n≥8, such as circular symmetric.

In an exemplary embodiment of the present compliant closed cell universal joint the body deformation restriction member 12 comprises a central member 13 which may be directly or indirectly attached to the first side 10a, and an eccentric member 14 which may be directly or indirectly attached to the second side 10b. The central member 13 is connected to the eccentric member 14. The term “central” [throughout the application] indicates that the member 13 is substantially in a central position of the body deformation member, such as exactly in the center thereof±a few percent of e.g. the diameter or height, respectively. The term “eccentric” [throughout the application] indicates that member 14 is off-center, such as close to the edge of body deformation restriction member 12, such as exactly at the edge thereof±a few percent of e.g. the diameter or height, respectively, or in the middle between the central axis and the edge, typically in a horizontal plane perpendicular to the central axis. One may consider the first side 10a being attached to the second side 10b by said body deformation restriction member. The body deformation restriction member may be a single element, such as a membrane-like element, or disk-shaped element, or may be formed by further elements. A compressive force applied on either or both of the first and second side causes forces of the body deformation restriction member, such that it me be considered to be pre-tensioned. Wobbling movement and the like of the closed cell universal joint, such as caused by components attached to the joint, is compensated by the body deformation restriction member, such that it prevents movement of the joint in selected directions.

In an exemplary embodiment of the present compliant closed cell universal joint the body deformation restriction member 12 comprises eccentric members 14 of which at least three first side eccentric members 14e are attached to the first side 10a and of which at least three second side eccentric members 14f are attached to the second side 10b, wherein eccentric members 14e each individually are connected to the eccentric member 14f. In this embodiment no central member is present, but only eccentric members. The eccentric members each individually are attached to one and another, that is a member 14e attached to the first side 10a is attached to a member 14f, attached to second side 10b. In particular the eccentric members may be of equal length, or of (slightly) different length, such that connectors 15 can cross one and another. In particular 3-36 eccentric members 14e and 3-36 eccentric members 14f may be provided, such as 4-24 eccentric members 14e,f, respectively.

In an exemplary embodiment of the present compliant closed cell universal joint the body deformation restriction member 12 comprises at least three connectors 15, in particular connecting a/the central member 13 and a/the eccentric member 14, more in particular 4-32 connectors 15. The connectors prevent movement of the joint in selected directions.

In an exemplary embodiment of the present compliant closed cell universal joint the body deformation restriction member 12 comprises at least one substantially flat connector 15, such as a film, a single layer, a multilayer.

In an exemplary embodiment of the present compliant closed cell universal joint comprises combinations of at least three connectors 15, and at least one substantially flat connector 15.

In an exemplary embodiment of the present compliant closed cell universal joint the connector 15 is a tube-like connector, such as a solid or hollow tube, or a rod-like connector, such as a cable, or a rope.

In an exemplary embodiment of the present compliant closed cell universal joint the connector 15 is made of a stiff material, such as nylon and steel, such as nylon 6,6.

In an exemplary embodiment of the present compliant closed cell universal joint the stretching stiffness of the connector is from 1-50000 N/m, such as 2.5-10000 N/m.

In an exemplary embodiment of the present compliant closed cell universal joint the stretching stiffness of the connector is >1.5 Fₛ/λD₁*f_{RJsafe}, wherein Fₛ is a maximum shear load, such as 25 N, or 2500 N, λD₁ is the maximum shearing displacement, and f_{RJsafe} a fail-safe factor, typically of ≥2. As such a fail-safe compliant closed cell universal joint is provided.

In an exemplary embodiment of the present compliant closed cell universal joint the body deformation restriction member 12 has a diameter L₀, wherein L₀<0.7* the outer diameter O_{d}, such as a diameter L₀ of 5-1000 mm, in particular of 10-500 mm, more in particular 50-300 mm.

In an exemplary embodiment of the present compliant closed cell universal joint a ratio between the outer diameter O_{d} and height H O_{d}:H is from 1-10, in particular from 2-8, such as 3-6. In view of performance and durability the ratio provides sufficient pressure balancing effect, as well as no internal contact up to 28° for a ratio of 4, and for other (D/H)-ratios no contact up to <5=22.6°; <6=18.9°; <7=16.3°; <8=14.3°; and <9=12.7°, respectively.

In an exemplary embodiment of the present compliant closed cell universal joint the body deformation restriction member 12 comprises a sub-connector 13a, in particular a solid sub-connector 13a, wherein the sub-connector 13a in particular comprises a tip 13b and a base 13c, wherein the base 13c is connected to the first side 10a and wherein the tip 13b is connected to a center of the body deformation restriction member 12.

In an exemplary embodiment of the present compliant closed cell universal joint the body deformation restriction member 12 comprises a sub-connector 14a, in particular a solid sub-connector 14a, wherein the sub-connector 14a in particular comprises a concave sub-connector 14b and a base 14c, wherein the base 14b is connected to the second side 10b and wherein the concave sub-connector 14b is connected to an eccentric part of the body deformation restriction member 12.

In an exemplary embodiment of the present compliant closed cell universal joint the base 13c, 14c each individually have a thickness of t₂, such as a thickness of 0.01-2 mm.

In an exemplary embodiment of the present compliant closed cell universal joint the wall of the elastic body has a thickness t₁ of 0.02-0.2* the height H of the elastic body. Such a thickness in relation to the height provides good characteristics in view of the invention.

In an exemplary embodiment of the present compliant closed cell universal joint the wall has a thickness t₁ of 0.001-5 mm.

In an exemplary embodiment of the present compliant closed cell universal joint the elastic body has a cross-sectional shape selected from ellipsoidal and circular.

In an exemplary embodiment of the present compliant closed cell universal joint the material of the wall is selected from elastomers, such as natural and synthetic polymers, in particular natural and synthetic rubbers, such as diene-comprising polymers, in particular polyisoprene, polybutadiene, fluoro-elastomers, and polychloroprene, non-diene-comprising polymers, in particular butyl rubber polyisobutylene, polysiloxanes, polyurethane, thermoplastic polymers, in particular SIS and SBS block copolymers, and urethanes, and metals, such as metal films. Typically these materials of the wall have an elastic modulus of 0.5 MPa-2 GPa, such as 10-100 MPa. However, nowadays also suitable materials with higher moduli could be used, such as up to 1000 GPa (ASTM E111).

In an exemplary embodiment of the present compliant closed cell universal joint the fluid is selected from substantially incompressible fluids. Such a fluid has a Poisson number close to 0.50, such as 0.45-0.50, in particular according to ASTM D638, ISO 527. A fluid whose density does not depend on the pressure is called incompressible—in contrast to compressible fluids. Examples are water, organic fluids, such as alkanes, alkanols, etc.

In an exemplary embodiment of the present compliant closed cell universal joint the joint comprises attached to the elastic body at least one attachment member 40, preferably at least one attachment member attached to the first side of the elastic body, and at least one attachment member attached to the second side of the elastic body. The at least one attachment member is at another side thereof attached to a first or second solid element, the solid elements forming part of the joint.

In an exemplary embodiment of the present compliant closed cell universal joint the at least one attachment member is symmetrical with respect to the central mirror plane parallel to said central rotation axis, such has having a two-fold or 2ⁿ-fold axis, or is asymmetrical with respect to the central mirror plane parallel to said central rotation axis, such has having a three-fold or m*3-fold axis, wherein m≥2, such as m=3-5.

In an exemplary embodiment of the present compliant closed cell universal joint the at least one attachment member comprises at least one positioning member 20. Such a positioning member supports the attachment of the attachment member to the present close cell universal joint, e.g. in terms of positioning thereof.

In an exemplary embodiment of the present compliant closed cell universal joint the at least one attachment member comprises at least one grip member 21.

In an exemplary embodiment of the present compliant closed cell universal joint the at least one attachment member comprises at least one spacing 22.

In an exemplary embodiment of the present compliant closed cell universal joint the at least one attachment member comprises at least one bottom plate 23, preferably a substantially circular bottom plate 23.

In an exemplary embodiment of the present compliant closed cell universal joint the at least one positioning member 20 comprises a receiving section 20a.

In an exemplary embodiment of the present compliant closed cell universal joint the joint comprises at least one fixator 30, preferably at least one fixator 30 at a bottom side of the elastic body, and at least one fixator 30 at an upper side of the elastic body.

In an exemplary embodiment of the present compliant closed cell universal joint the at least one fixator 30 comprises at least one screw member 30a.

In an exemplary embodiment of the present compliant closed cell universal joint the material of the attachment member is selected from thermoset and thermoplastic polymers, such as PE.

The invention is further detailed by the accompanying figures and examples, which are exemplary and explanatory of nature and are not limiting the scope of the invention. To the person skilled in the art it may be clear that many variants, being obvious or not, may be conceivable falling within the scope of protection, defined by the present claims.

### SUMMARY OF FIGURES

FIGS. 1A-1C, 2, 3A-3D, and 4 show experimental details.

### DETAILED DESCRIPTION OF FIGURES

In the figures:
1 compliant closed cell joint
10 hollow elastic body
10a first side
10b second side
11 wall of elastic body
12 body deformation restriction member
13 central member of body deformation restriction member
13a sub-connector
13b tip
13c base
14 eccentric member of body deformation restriction member
14a solid sub-connector
14b concave sub-connector
14c base
14e eccentric member attached to first side 10a
14f eccentric member attached to second side 10b
15 connector
20 positioning member
20a receiving section
21 grip member
22 spacing
23 bottom plate
30 fixator
30a screw member
40 attachment member
51 cable fixation mechanism
52 cable entry
53 cable pillar
54 internal cable mounting point
55 external cable mounting point
56 external bottom connector, typically rigid
57 inner bottom connector, typically rigid
58 inner top connector, typically rigid
59 external top connector, typically rigid
D₁ diameter eccentric member
D₂ diameter cable/connector
E₁ elastic modulus wall
E₂ elastic modulus cable/connector
H height of hollow elastic body
I_{d} inner diameter elastic body
L₀ length or diameter of central member
t₁ thickness of wall of elastic body
t₂ thickness of base
O_{d} outer diameter elastic body
ν₁ Poisson ratio
ν₂ Poisson ratio
V volume elastic body

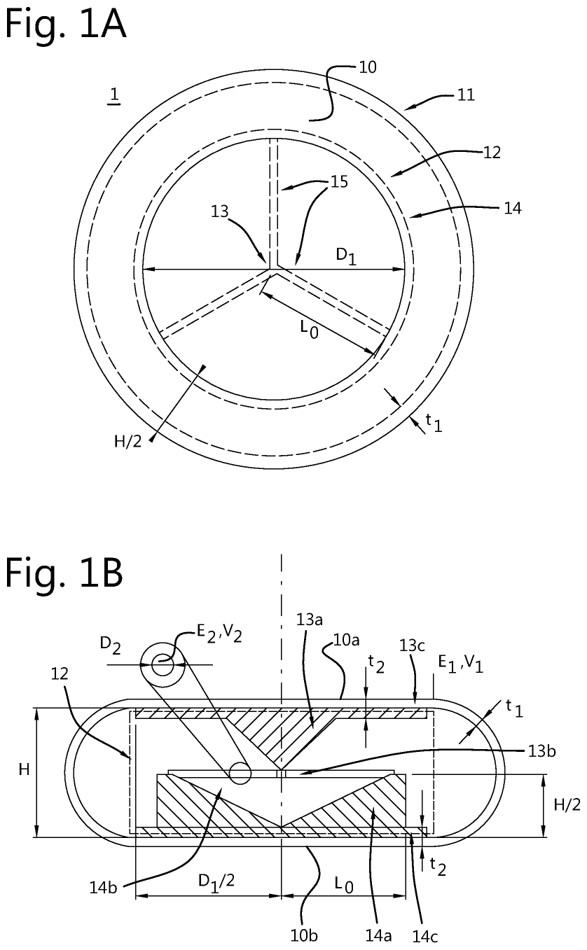

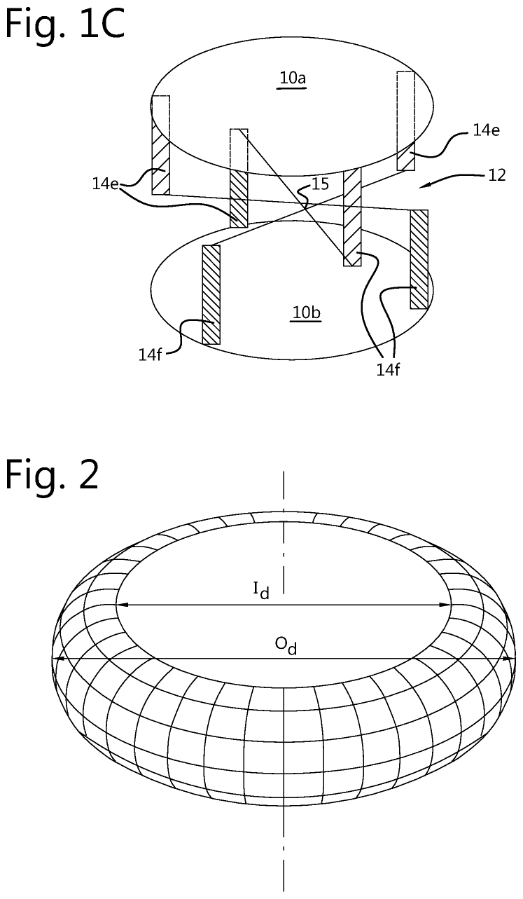

FIG. 1A shows a cross-sectional top view of an embodiment.

FIG. 1B shows a cross-sectional side view of an embodiment, and further details of the embodiment of FIG. 1B.

FIG. 1C shows an alternative body deformation member with only eccentric members. Reference numbers are as above.

FIG. 2 shows an examples of suitable volumes for the present compliant joint, which typically have a torus shape, and central axis.

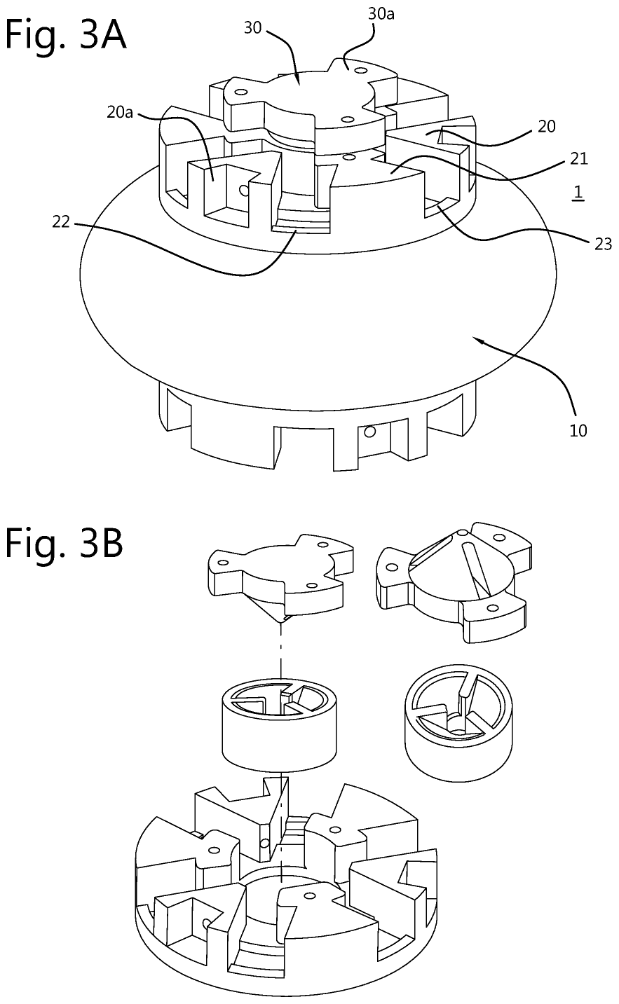

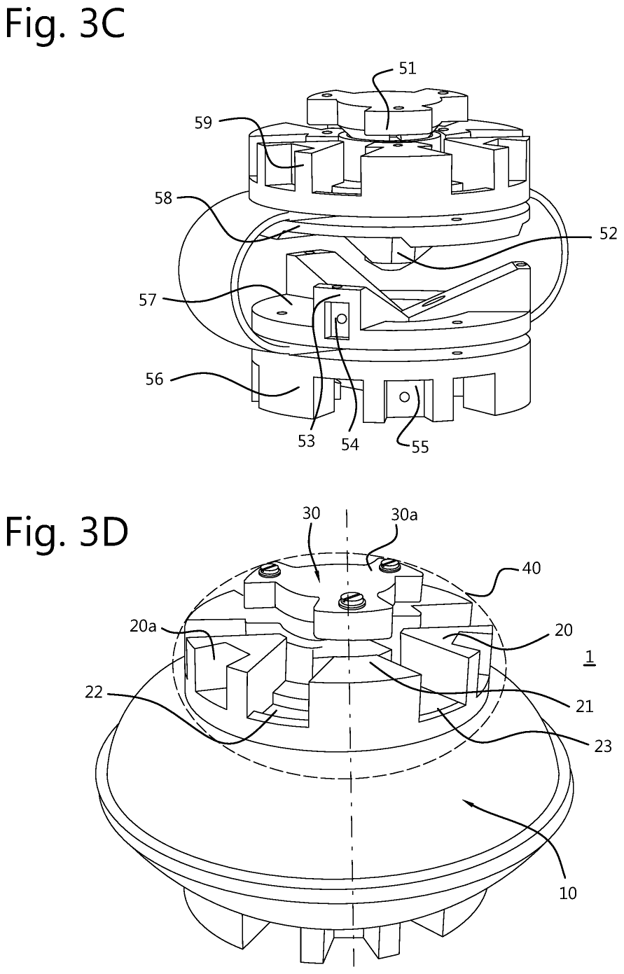

FIGS. 3A-3D show an example of the present compliant joint used in experiments, and built up of said joint.

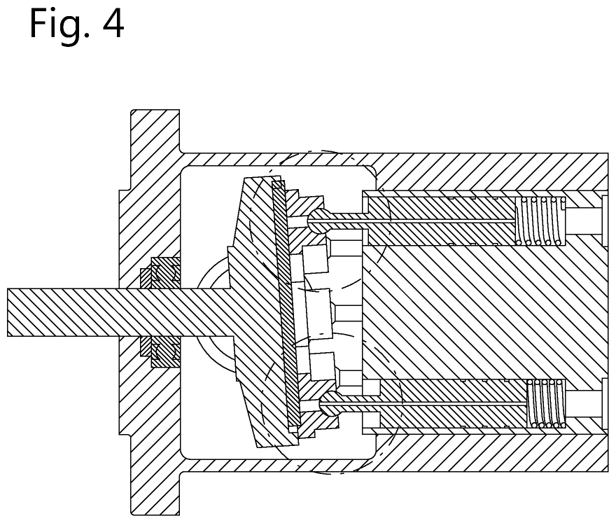

FIG. 4 shows a wobble plate piston pump. Design requirements for said pump used in the experimental set-up were: Rotate 10° under Fₐₓᵢₐₗ=65 [N]; Kᵣₒₜₐₜᵢₒₙ<1.90 [Nm/rad]; and

Shear displacement <0.7 [mm] for Fₛₕₑₐᵣ=25 [N]. In general the Kᵣₒₜₐₜᵢₒₙ may be from about 1-100 [Nm/rad], in particular 1.5-50 [Nm/rad], more in particular 1.7-10 [Nm/rad], such as 1.9-5 [Nm/rad].

The figures are further detailed in the description.

The invention although described in detailed explanatory context may be best understood in conjunction with the accompanying figures.

### Experimental Results

Hydraulic systems are a commonly used component in many applications to deliver an effective supply of power. Two conventional examples of such hydraulic systems are the wobble plate and the swashplate piston pumps, schematically shown in FIG. 4. The fundamental working principle of these pumps lies in the tilted position of the plate. By rotating the plate or piston-cylinder assembly, dependent on the type of pump, a reciprocal movement is created in the pistons, which can be used to generate pressure in the cylinders. Although different versions of these pumps have been developed, some functional components like the slipper and ball-socket joint have remained the same over time. A failure of a component within these systems usually has significant consequences. Downtime of these systems is often accompanied by tremendous costs, which is related to the loss of production and the costs of repairs. It is therefore important that the functional components operate consistently with a minimal risk of failure. The components most prone to a failure in these systems are usually the bearing elements that are loaded in partial or full contact.

In an experimental set-up the following design requirements have been used:

TABLE 1
Relevant parameters of the test setup
for the pressure balanced joint.

| Parameter | Symbol | Value Unit | |
|---|---|---|---|
| Compression load | F_{c} | 65 | [N] |
| Shear load | Fₛ | 25 | [N] |
| Slipper rotation stiffness | K_{RS} | 190 | [Nm/rad] |
| Wobble plate angle | A_{w} | 10 | [°] |
| Maximum bearing diameter | D_{SM} | 70 | [mm] |

Based on the parameters presented in Table 1, both design requirements and objectives have been formulated for the case study. The requirements are defined as follows: R1 The joint should allow a minimum rotation of 10° in any tip-tilt direction, also when the joint is compressed by the maximum compression load of Fc=65(N). R2 The joint should minimize shear movements below λ=1% of the slipper diameter at the maximum shear force Fs=25(N), to minimize drift of the slipper over the wobble plate surface. R3 The horizontal segments of the joint should have a maximum diameter of 70 (mm). The general embodiment for the detailed design is shown in FIG. 1A-1C. Such a design is found to give good behavior, e.g. in terms of compression under load, of rotation under torque, and stiffness. Typical design parameters are given in table 2 (with reference to FIG. 1).

TABLE 2
Design parameters of compliant universal joint.

| Parameter | Symbol | Value Unit | |
|---|---|---|---|
| Cell flat diameter | D₁ | 55 | [mm] |
| Cell inner height | H | 25 | [mm] |
| Cell wall thickness | t₁ | 1.5 | [mm] |
| Cell Youngs modulus | E₁ | 1.53 | [MPa] |
| Cell Poisson ratio | v₁ | 0.49 | [—] |
| Clamping thickness | t₂ | 2.0 | [mm] |
| Cable diameter | D₂ | 1.15 | [mm] |
| Cable initial length | L₀ | 23 | [mm] |
| Cable Youngs modulus | E₂ | 4.0 | [GPa] |
| Cable Poisson ratio | v₂ | 0.35 | [—] |

Such a design is found to result in the following performance.

TABLE 3
Designed performance of the compliant universal joint.

| Stiffness | Symbol | Value Unit | |
|---|---|---|---|
| Axial secant stiffness | K_{AJ} | 22.1 | [kN/m] |
| Rotational secant stiffness (loaded) | K_{RJ} | 1.76 | [Nm/rad] |
| Rotational secant stiffness (unloaded) | K_{RJP} | 0.60 | [Nm/rad] |
| Single cable stiffness | K_{c0} | 180 | [kN/m] |
| Minimum system shear stiffness | K_{Smin} | 90 | [kN/m] |

It was found that predicted and measured behavior mostly overlapped. The designed cell has good axial stiffness, rotational stiffness, and shear stiffness.

The compliant piston-slipper mechanism is found to be a good alternative to the contact mechanics based mechanisms that can be found in the state of the art. The coupling in stiffness directions in compliant mechanisms creates the need for a combination of sub-systems that together are able to create a functional alternative to the state of the art. The case study further builds on the potential of closed form pressure balancing and passive shape shifting, and shows how the combination can form a compliant alternative. The case study presents a simplified load case. The present invention shows that the introduction of compliance into components that are traditionally high-stiffness result in desirable performance for next generation wobble plate piston pumps.

It should be appreciated that for commercial application it may be preferable to use one or more variations of the present system, which would be similar to the ones disclosed in the present application and are within the spirit of the invention.

1. A compliant closed cell universal joint comprising
a hollow elastic body having a wall, the elastic body having an outer diameter O_{d}, the elastic body having a height H, the elastic body having a volume V, a first side, a second side opposite of the first side, at least one central axis, and a body deformation restriction member, wherein the body deformation restriction member is at least one f attached to the wall and incorporated into the wall, for providing shear stiffness in a plane perpendicular to the at least one central axis, and
an elastic material with a constant density ρ inside the hollow elastic body.

2. The compliant closed cell universal joint according to claim 1,
wherein the body deformation restriction member is symmetrical with respect to the central axis.

3. The compliant closed cell universal joint according to claim 1, wherein the body deformation restriction member comprises one of (i) a central member attached to the first side, and an eccentric member attached to the second side, wherein central member is connected to the eccentric member, and
(ii) eccentric members of which at least three first side eccentric members are attached to the first side and of which at least three second side eccentric members are attached to the second side, wherein eccentric members each individually are connected to the eccentric member.

4. The compliant closed cell universal joint according to claim 1,
wherein the body deformation restriction member comprises at least three connectors, connecting a/the central member and a/the eccentric member, and
wherein the body deformation restriction member comprises at least one substantially flat connector.

5. The compliant closed cell universal joint according to claim 4, wherein the connector is selected from a tube-like connector and a rod-like connector.

6. The compliant closed cell universal joint according to claim 4, wherein the connector is made of a stiff material, and
wherein the stretching stiffness of the connector is from 1-50000 N/m, and
wherein the stretching stiffness of the connector is >1.5 Fₛ/λD₁*f_{RJsafe}, wherein Fs is a maximum shear load, λD₁ is the maximum shearing displacement, and f_{RJsafe} a fail-safe factor.

7. The compliant closed cell universal joint according to claim 1, wherein the body deformation restriction member has a diameter L₀, wherein L₀<0.7* the outer diameter O_{d}, and a L₀ of 5-1000 mm, and
wherein a ratio between the outer diameter O_{d} and height H O_{d}:H is from 1-10, and
wherein the body deformation restriction member comprises a first sub-connector, in particular a solid sub-connector, wherein the first sub-connector comprises a tip and a base, wherein the base is connected to the first side and wherein the tip is connected to a centre of the body deformation restriction member, and
wherein the body deformation restriction member comprises a second sub-connector, wherein the second sub-connector comprises a concave third sub-connector and a base, wherein the base is connected to the second side and wherein the concave third sub-connector is connected to an eccentric part of the body deformation restriction member, and wherein the base each individually have a thickness of t₂.

8. The compliant closed cell universal joint according to claim 1,
wherein the wall of the elastic body has a thickness t₁ of 0.02-0.2* the height H of the elastic body, and
wherein the wall has a thickness t₁ of 0.001-5 mm, and/or
wherein the elastic body has a cross-sectional shape selected from ellipsoidal and circular.

9. The compliant closed cell universal joint according to claim 1,
wherein the material of the wall is selected from elastomers, and metal films.

10. The compliant closed cell universal joint according to claim 1, wherein the fluid is selected from substantially incompressible fluids selected from water, organic fluids, alkanes, and alkanols.

11. The compliant closed cell universal joint according to claim 1,
wherein the joint comprises attached to the elastic body at least one attachment member, attached to the side of the elastic body.

12. The compliant closed cell universal joint according to claim 11, wherein the at least one attachment member is selected from a symmetrical attachment member with respect to the central mirror plane parallel to said central rotation axis, and from an asymmetrical attachment member with respect to the central mirror plane parallel to said central rotation axis.

13. The compliant closed cell universal joint according to claim 11,
wherein the at least one attachment member comprises at least one positioning member, and
wherein the at least one attachment member comprises at least one grip member, and
wherein the at least one attachment member comprises at least one spacing, and
wherein the at least one attachment member comprises at least one bottom plate.

14. The compliant closed cell universal joint according to claim 13, wherein the at least one positioning member comprises a receiving section.

15. The compliant closed cell universal joint according to claim 1, wherein the joint comprises at least one fixator, selected from at least one fixator at a bottom side of the elastic body, and at least one fixator at an upper side of the elastic body.

16. The compliant closed cell universal joint according to claim 1, wherein the at least one fixator comprises at least one screw member.

17. The compliant closed cell universal joint according to claim 1, wherein the material of the attachment member is selected from thermoset and thermoplastic polymers.

18.-19. (canceled)

20. Product comprising the compliant closed cell universal joint according to claim 1, selected from a piston, a piston pump, a wobble plate piston pump, a swashplate piston pump, a bearing element, a wind turbine, an axial piston pump, an industrial robot with limited axial freedom, and a hinge.

21. The compliant closed cell universal joint according to claim 1, wherein the elastic material has a bulk modulus of 0.5-10 GPa, and a density ρ of 0.8-3 kg/dm³, and a Poisson's ratio of 0.48-0.50.
